(19) United States
(12) Patent Application Publication
(10) Pub. No.: US 2026/0172266 A1
(43) Pub. Date: Jun. 18, 2026

(54) NETWORK REPOSITORY FUNCTION CERTIFICATE EVALUATION

(71) Applicant: Oracle International Corporation, Redwood City, CA (US)

(72) Inventors: John Mohan Raj, Bengaluru (IN); Uri Baniel, Buffalo Grove, IL (US); Yesh Goel, Bengaluru (IN)

(21) Appl. No.: 18/986,282

(22) Filed: Dec. 18, 2024

(51) Int. Cl. H04L 9/32; H04L 9/08

(52) U.S. Cl. CPC H04L 9/3268; H04L 9/0825

(57) ABSTRACT

Various embodiments of the present technology generally relate to systems and methods for monitoring the validity of public key certificates of network functions (NFs) at a network repository function (NRF), and sending notifications or adjusting behavior when a certificate has expired. In some embodiments, a method may comprise operating a NRF of a mobile network, including receiving a public key certificate from a first NF, wherein the public key certificate includes a validity period, monitoring the validity period for expiration, and setting a status of the first NF to suspended in response to the validity period expiring.

### TECHNICAL FIELD

Various embodiments of the present technology generally relate to management of certificates for network functions (NFs) within a network. More specifically, embodiments of the present technology relate to systems and methods for handling the expiration of network certificates via a network repository function (NRF).

### BACKGROUND

Communications networks can be used to connect remote systems and devices, allowing for distributed and efficient processing, resource use, and intercommunication. Within a network, there may be a variety of resources available for access, each resource available from one or more systems. Specifically, network functions (NFs) serve to provide a resource or functionality to various components and user equipment (UE) used on the wireless network. For example, network functions perform tasks such as session management (e.g., session management function (SMF)), policy control (e.g., policy control function (PCF)), access and mobility (e.g., access and mobility management function (AMF)), and so forth. NFs can register with a network repository functions (NRF) that stores information about the NF, including availability and access information (e.g., a network address for a system or component that provides the NF). A consumer NF (C-NF) seeking a service may query the NRF for a list of producer NFs (P-NFs) that can provide the service, after which the consumer NF can establish a connection with a selected producer NF.

In order to communicate, NFs may establish service-based interface (SBI) encrypted communication sessions. Establishing an encrypted communication session may include performing a handshake operation during which secure socket layer (SSL) or transport layer security (TLS) digital certificate is exchanged. An SSL or TLS certificate may be a digital object that allows systems to verify the identity of and establish an encrypted network connection to another system using the Secure Sockets Layer or Transport Layer Security (SSL/TLS) protocol. Certificates may be used within a cryptographic system known as a public key infrastructure (PKI). PKI provides a way for one party to establish the identity of another party using certificates issued by a trusted party known as a certificate authority. For ease of use herein, certificates may be referred to as TLS certificates, although the scope of this disclosure is not limited thereto.

Exchanged certificates may have a validity period indicating how long the certificate is considered reliable and active. If a system's certificate has expired, the system may be unable to establish a new connection with other systems. Ideally TLS certificates should be renewed (either manually or automatically) before their validity period expires, but this may not always occur. For cases in which TLS certificates are not timely renewed, for example due to some internal automation error or provisioning issues etc., all future SBI connections to these NFs may be rejected, causing loss of serviceability.

According to 3GPP (third generation partnership project) standards, an NRF may not track certificate expiration. Due to this, an NRF may provide a consumer NF with the information of a producer NF having an expired certificate, resulting in the consumer NF attempting and failing to establish a connection with the producer. This may cause service delays or failures. Accordingly, improvements are needed for managing digital certificates within a network.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for providing a positive response to a query for a suspended resource. In an embodiment, a Network Repository Function (NRF) system may comprise one or more processors, and a memory having stored thereon instructions. The instructions, upon execution, may cause the one or more processors to receive a public key certificate from a first network function (NF), wherein the public key certificate includes a validity period, monitor the validity period for expiration, and set a status of the first NF to suspended in response to the validity period expiring.

In some embodiments, the NRF system may receive a discovery request from a second NF seeking information on a set of one or more NFs that includes the first NF, and not provide information on the first NF in response to the discovery request based on the first NF being suspended due to expiration of the public key certificate. The NRF system may receive a subscription request from the second NF requesting updates on NFs that are suspended due to expiration of corresponding public key certificates, and send a notification to the second NF based on the subscription request and setting the status of the first NF to suspended. In some examples, the NRF system may receive the public key certificate during a first transport layer security (TLS) handshake operation with the first NF, receive an updated public key certificate during a second TLS handshake operation with the first NF, the updated public key certificate having a new validity period, determine that the new validity period is active, and update the status of the first NF from suspended to registered based on the updated public key certificate. The NRF system may send a second notification to the second NF based on the subscription request and updating the status of the first NF from suspended to registered, wherein the subscription request requests updates on NFs that are registered. In some embodiments, the NRF system may receive a second subscription request from the first NF requesting an update when the first NF is changed to suspended status due to expiration of the public key certificate, and send a third notification to the first NF based on the second subscription request and setting the status of the first NF to suspended. The NRF system may receive the second subscription request, further requesting an update when the public key certificate is approaching expiration, monitor the validity period for being within a selected threshold time of expiring, and send a fourth notification to the first NF based on the second subscription request and the validity period being within the selected threshold time of expiring. In some embodiments, the NRF system may send notifications regarding the first NF being suspended due to the validity period expiring based on explicit subscriptions created between NFs and the NRF, wherein notification event types for the explicit subscriptions include suspension due to certificate expiration. In some examples, the notification event types for the explicit subscriptions include certificates approaching expiration. According to some embodiments, the NRF system may receive a request to create an NF profile at the NRF for a second NF, the request including a default uniform resource identifier (URI) for receiving notifications, and send a notification to a second NF indicating that the first NF has been suspended due to certificate expiration, the notification being sent via implicit subscription to the default URI utilizing a custom notification type.

In an alternative embodiment, a method may comprise operating a network repository function (NRF) of a mobile network, including receiving a public key certificate from a first network function (NF), wherein the public key certificate includes a validity period, monitoring the validity period for expiration, and setting a status of the first NF to suspended in response to the validity period expiring.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a diagram of an operational environment of a system configured to perform network repository function certificate evaluation, in accordance with certain embodiments of the present disclosure;

FIG. 2 is a diagram of a system configured to perform network repository function certificate evaluation, in accordance with certain embodiments of the present disclosure;

FIG. 3 is a set of tables for a system configured to perform network repository function certificate evaluation, in accordance with certain embodiments of the present disclosure;

FIG. 4 depicts a process flow diagram of a system configured to perform network repository function certificate evaluation, in accordance with certain embodiments of the present disclosure;

FIG. 5 depicts a flowchart of an example method for performing network repository function certificate evaluation, in accordance with certain embodiments of the present disclosure; and

FIG. 6 illustrates a computing system configured to perform network repository function certificate evaluation, in accordance with some embodiments of the present technology.

Some components or operations may be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

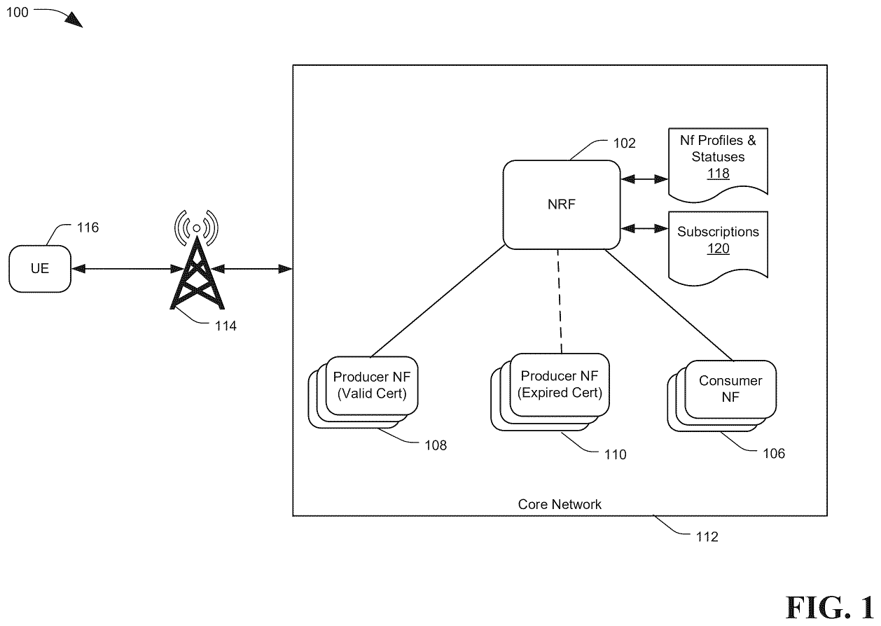

FIG. 1 is a diagram of a system 100 configured to perform network repository function certificate evaluation, in accordance with certain embodiments of the present disclosure. The example system 100 may include a 5G mobile network implementing 3GPP (3rd Generation Partnership Project) communication standards (e.g., using the TS 29.510 technical specification) having network functions (NFs) as resources, although the present disclosure may apply to other communication networks and associated resources. The system 100 may include one or more user equipment (UE) 116 connected to a core network 112 via network connectivity components 114.

UE 116 may be a device, system, or module that may utilize the resources of the core network 112, such as to establish mobile communications with another UE. UE 116 may include mobile devices such as cell phones, tablets, or modems.

Network connectivity components 114 may comprise components that enable communication over communication links, such as network cards, ports, radio frequency (RF) modules, telecommunications channels, cell towers, processing circuitry and software, or other communication components. Network connectivity components 114 may include metallic, wireless, cellular, or optical links, using various communication formats and protocols. In some examples, network connectivity components 114 may simply be referred to as a “network” by which systems or modules are connected or communicate.

The core network 112 may include the part of a mobile communications network that provides services to UEs through the network connectivity components 114. The core network 112 may include a plurality of NFs 106, 108, 110, and a network repository function or NF repository function (NRF) 102. The components of core network 112, or the physical devices implementing them, may be co-located, remotely distributed, or any combination thereof. Each or any of UE 116, NRF 102, NFs 106, 108, 110, and network 114 may be implemented via computers, servers, hardware and software modules, or other system components. The elements of system 100 may include components hosted or situated in the cloud, and implemented as software modules potentially distributed across one or more server devices or other physical components.

Network functions (NFs) 106, 108, 110 may act as functional building blocks of the network infrastructure. Each NF may have a well-defined external interface (e.g., a communications or software interface expecting specified inputs and producing specified outputs) and functional behavior, and may include a network node or module, a physical appliance, or other component. For example, network functions perform tasks such as session management (e.g., session management function (SMF)), policy control (e.g., policy control function (PCF)), access and mobility (e.g., access and mobility management function (AMF)), data management (e.g., unified data management function (UDM)) and so forth. In the depicted example, NFs may be categorized as consumer NFs (C-NFs) 106, and various producer NFs (P-NFs), including producer NFs (valid certificate) 108, and producer NFs (expired certificate) 110. The distinctions between these NF components will be addressed below.

A network repository function or NF repository function (NRF) 102 may be a monitoring element which includes and maintains a repository of the NF elements of the network, including what services or resources each provides. The repository of NF profiles and statuses may include identifying information for NFs (e.g., ID numbers), type of NF or services provided, functions supported (e.g., including vendor-specific functions or features), and status information such as whether an NF is registered or suspended. The repository may be in the form of a database or other data structure of NF profiles and statuses 118. The NRF 102 may perform both discovery operations to add NFs to the NRF database, as well as operations to keep the NRF updated. For example, NFs may register with the NRF to provide registration information for the NF to the NRF for storing in the repository 118. The NRF 102 may create an NFProfile for each NF that registers with the NRF 102, and store the NFProfiles in the repository 118. The NFProfiles may include various information about the corresponding NF, which information may be utilized by the NRF 102, provided to other NFs in response to discovery requests, or both. Once an NF is registered with the NRF, the NRF may provide information regarding the NF in response to discovery requests.

An NRF 102 may also manage subscriptions 120 and related subscription notifications. For example, a C-NF 106 may subscribe to NRF 102 to receive status updates according to specified criteria. The criteria may include what target NFs the C-NF 106 wants updates for (e.g., a particular kind of P-NF, or a specific identified NF, etc.), and what kind of status updates the C-NF 106 wants (e.g., when a target NF is added or removed from the network, or changes status from “registered” to “suspended,” etc.). The NRF 102 may maintain a database or other data structure of subscriptions 120, including which NFs have created subscriptions, and the specified criteria on which to notify the subscribed NFs.

Further, the NRF 102 may receive heartbeat signals or updates at regular or expected intervals from the various NFs 106, 108, 110, so that the NRF 102 may be aware of the status of the NFs. To enable the heartbeat signal, SBI connections may be established between the NFs and the NRF, for example using a TLS handshake process. Establishing the SBI connection may involve the NF providing a digital certificate with a public key of the NF. Public key certificates may include a validity period during which the certificate is considered valid and accepted by other network elements. If a certificate has expired, the certificate may need to be renewed with a new validity period in order to successfully complete the TLS handshake process and establish new SBI connections. The public key certificates may also include a “subjectAltName” extension (e.g., defined in 3GPP TS 33.310 section 6.1.3c.3) which consists of an NF Instance Id of the NF itself.

In the depicted example, NFs may be categorized as consumer NFs 106, producer NFs (valid certificate) 108, and producer NFs (expired certificate) 110. A consumer NF 106 may include an NF issuing a discovery or resource request (e.g., to NRF 102) in order to access a resource provided by a producer NF. A producer NF 108, 110 may be an NF that offers a resource corresponding to a resource request from a consumer NF 106. While the NFs in the depicted example are categorized into “consumer” and “producer” NFs, the distinction may be purely based on which nodes are currently issuing NF discovery requests and which nodes may match or satisfy the requested criteria. A consumer NF may provide resources to the network, and may be a producer NF to other NF discovery requests, and likewise a producer NF may issue a discovery request and be a consumer NF.

In an example process, a consumer NF 106 may issue an NF discovery or resource request to the NRF 102 to locate a specified resource or functionality. The NRF 102 may consult the NF repository 118 for producer NFs 108, 110 that satisfy the requested criteria. According to the 3GPP specification, the NRF 102 may include data (e.g., access information) in the discovery response for producer NFs that are registered, e.g. due to having an established heartbeat connection with the NRF 102. The C-NF 106 may use the discovery response information to attempt to establish a connection to a P-NF and obtain the desires service or resource.

A producer NF (valid certificate) 108 may be an NF that has registered with the NRF 102, and has a digital certificate that is still within an active validity period. If the NRF 102 provides the information for a P-NF (valid certificate) 108 in response to a discovery request from the C-NF 106, the C-NF 106 may be able to establish a connection with the P-NF (valid cert) 108 because the certificate is valid. A producer NF (expired certificate) 110 may be an NF that has registered with the NRF 102, and may even have established an active SBI connection with the NRF 102 to provide heartbeat signals while its certificate was valid. However, after the P-NF (expired cert) 110 registered with NRF 102, the NF's certificate may have expired. Expiration of the certificate may not end already-established SBI connections, and therefore the P-NF (expired cert) 110 can still communicate with the NRF 102. If the NRF 102 provides the information for a P-NF (expired certificate) 110 in response to a discovery request from the C-NF 106, the C-NF 106 may be unable to establish a connection with the P-NF (expired cert) 110 because the certificate has expired and is no longer valid. The C-NF 106 may need to wait for the connection attempt to fail, and then select and connect to an alternate P-NF 108 in order to obtain the required service. This can lead to service failures or delays, e.g., in providing service for a UE 116. In some instances, once a C-NF 106 has a list of potential P-NFs 108, 110, it may not query the NRF 102 for P-NFs every time the C-NF 106 needs a service, and may simply reach out to a P-NF from the list. If a certificate of a P-NF 110 expires after the C-NF 106 received the list, the C-NF may still attempt and fail to establish a connection with the P-NF (expired cert) 110, again leading to service failures or delays.

To address these issues, the NRF 102 may be configured to store TLS certificate data for producer NFs in the NF profiles and statuses repository 118, including expiry or validity period information. The NRF 102 may audit the certificate expiration periods to determine when a certificate has expired, or is approaching expiration. If a certificate for a producer NF 110 expires, the NRF 102 may update the status of the P-NF 110 in the NF profiles and status repository 118 to a “Suspended due to certificate expiration” status. The NRF 102 may no longer provide the information for a P-NF 110 with an expired certificate in response to discovery requests from C-NFs 106. Further, the NRF 102 may send out notifications to any NFs subscribed for suspended status information for P-NFs, according to the subscriptions list 120. This may include informing C-NFs 106 that a P-NF 110 has an expired certificate and should not be contacted for service.

Further, in some examples a P-NF 108, 110 can subscribe to the NRF 102 for status updates on itself. In these cases, the NRF 102 may provide the P-NF (expired cert) 110 a notification that the P-NF's certificate has expired and should be renewed, or the NRF 102 may even notify the P-NF prior to certificate expiration, so that the P-NF 108 can renew its certificate before it expires, and prevent service interruptions. In this manner, the impact from expired certificates can be avoided or minimized within core network 112.

If a P-NF (expired cert) 110 listed in the NF profiles and statuses database 118 as having a “suspended due to certificate expiration” status, it can renew its certificate an establish a new SBI connection with NRF 102. The NRF 102 may evaluate the certificate validity period and update the P-NFs status to “registered”, thereby converting a P-NF (expired cert) 110 into a P-NF (valid cert) 108. Any NFs subscribed for status updates for that particular P-NF or class of P-NFs may receive an update from the NRF 102 indicating that the P-NF is now registered and a valid target for new SBI connections.

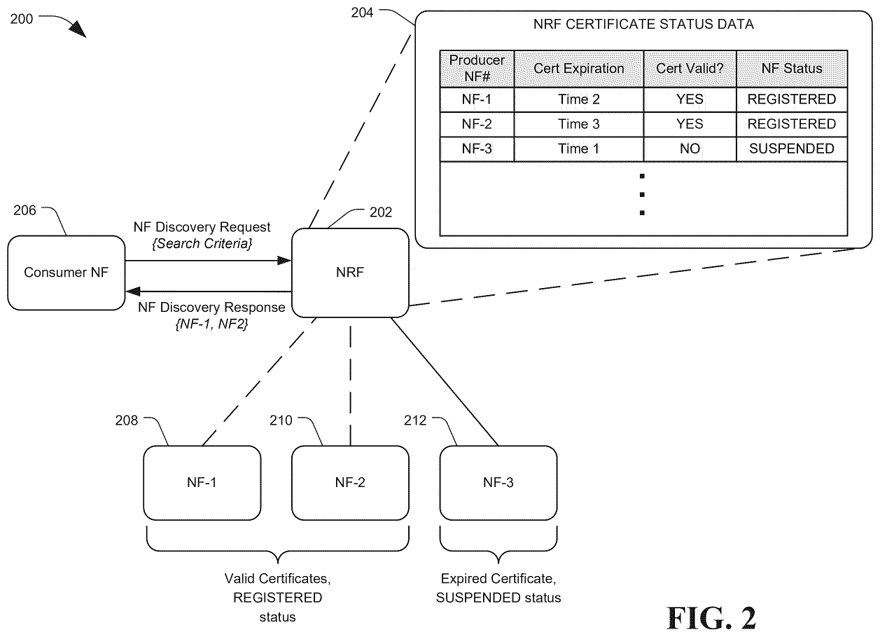

The improved functionality provided by an NRF that audits certificate expiration, updates NF statuses, and provides status update notifications can be implemented via, e.g., adjusting or update existing application programming interfaces (APIs) toward NFs from the NRF 102. The augmented API may include adding one or more new status categories for certificate expiration, and using implicit or explicit subscriptions to notify NFs about the certificate expiry statuses. An example system for NRFs performing certificate evaluation is described in regard to FIG. 2.

FIG. 2 is a diagram of a system 200 configured to perform network repository function certificate evaluation, in accordance with certain embodiments of the present disclosure. System 200 may include a consumer NF 206, an NRF 202, and its associated NF certificate status data 204 for NFs in a network, and a plurality of producer NFs, NF-1 208, NF-2 210, and NF-3 212.

The NRF 202 may maintain a repository, database, table, or other data structure including status information for NFs in a network. In the example embodiment, the NRF current state table 204 may include fields such as producer NF#, a certificate expiration time, date, or validity period, a “certificate valid?” field, and an NF status field.

The producer NF# field may include identifiers for various NFs in the network, which may take the form of a network address, device identifier, module or node identifier, other identifying information, or a combination thereof. For example, the NRF 202 may track NFs according to an NF instance ID number. When an NF establishes an SBI connection with the NRF 202, the NF may provide a public key certificate with a “subjectAltName” extension or field that includes the NF Instance ID, so that the NRF 202 can associate the certificate with an NF Instance ID value.

The certificate expiration field may list a time, date, duration, or validity period up to which or during which the public key certificate used to establish the SBI connection is valid. For example, the validity period may identify a number of minutes, hours, or days the certificate should be considered valid, or the certificate may specify a specific time or date at which the certificate expires. The validity period may be set by a trusted certificate authority (CA) that issues the public key certificate, after which period the certificate should not be trusted. The “cert valid?” field may include a flag, toggle, or value that indicates whether the certificate expiration time or duration has been exceeded, and therefore whether the certificate is valid or invalid.

The “NF status” data field may indicate whether an NF is “registered” or “suspended”. An NF with the registered status may be considered a stable part of the network (e.g., it has established a heartbeat connection to the NRF 202 and has a valid public key certificate), and a valid target for discovery requests. Meanwhile, a suspended NF may have established a heartbeat connection or registered with the NRF 202 previously, but has been suspended or become inactive for some reason, such as losing connectivity or, in the present example, having an expired public key certificate.

In the depicted example, NF-1 208, NF-2 210, and NF-3 212 may have registered with the NRF 202 and been added to the NF repository database, including NRF certificate status data 204. When each NF registers with the NRF 202 or establishes and SBI connection (e.g., for a heartbeat signal connection), the NRF 202 may record the corresponding the certificate validity period or expiration time in the certificate status data 204. Assuming each NF has a valid certificate at the time of registering, each NF may be added to the certificate status data with a “registered” status, and a “yes” in the “cert valid?” field. When NFs submit discovery requests to the NRF 202, NFs matching the discovery criteria and having a “registered” status may be provided in the discovery response.

Periodically (e.g., at selected intervals or according to one or more trigger events), the NRF 202 may perform an audit on the validity periods of NFs in the certificate status data 204. If the NRF 202 identifies an NF having a certificate that has expired, such as NF-3 212, the NRF 202 may update the certificate status data 204 to include a “no” in the “cert valid?” field, and change the NF status to “suspended”, or “suspended due to certificate expiration”. If an NF issues a discovery request that would include NF-1 208, NF-2 210, and NF-3 212, the NRF 202 may check the certificate status data 204 and only return information for NFs having the “registered” status. Accordingly, the NF discovery response may include NF-1 208 and NF-2 210, but may not include NF-3 212 due to it having a “suspended due to certificate expiration” status.

Any NFs subscribed to NRF 202 for status updates for NF-1 208, NF-2 210, and NF-3 212 may receive a notification when NF-3 212 is changed from “registered” to “suspended due to certificate expiration”. Any NFs that had previously received a list of valid registered NFs that included NF-3 212 may therefore be made aware that the certificate has expired and new SBI connections with the suspended NF may not be possible. Even NF-3 212 may have subscribed for its own status information, and may receive an update indicating that it has been suspended due to certificate expiration.

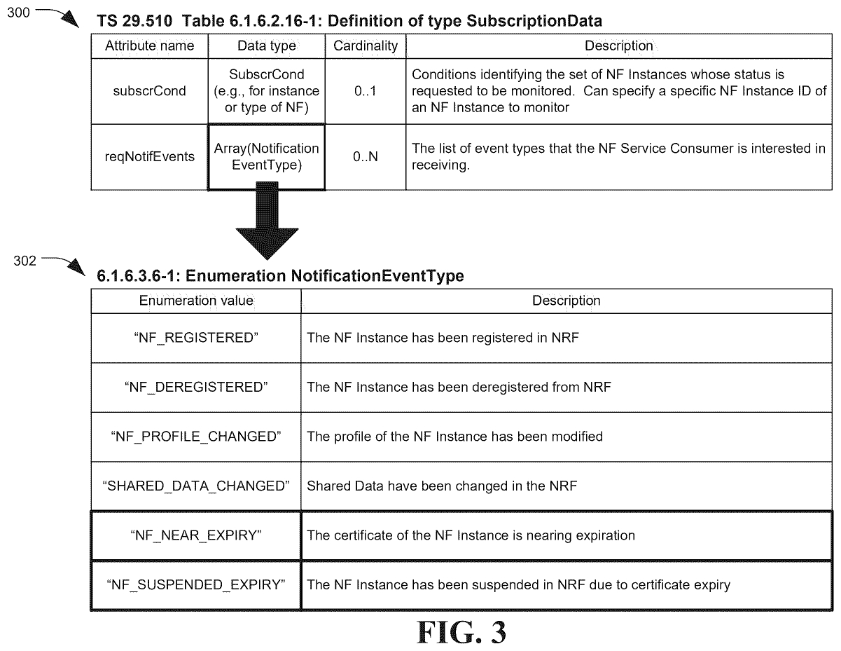

During certificate validity audits, the NRF 202 may be configured to note certificates that are not yet expired, but are approaching expiration. The NRF 202 may send notification updates to the corresponding NF (e.g., NF-3 212), or potentially to other subscribed NFs, indicating that the certificate is approaching expiration and should be renewed. Example API updates for implementing NRF certificate evaluation are described in regard to FIG. 3.

FIG. 3 is a set of tables for a system configured to perform network repository function certificate evaluation, in accordance with certain embodiments of the present disclosure. In particular, FIG. 3 depicts updates to existing standards utilized by 3GPP specifications, in order to enhance the existing API to support the NRF certificate evaluation operations proposed herein. The tables may include a SubscriptionData type table 300, and a NotificationEventType enumeration table 302. The tables may define data types recognized by 3GPP standards-based network functions for performing various operations.

NRF certificate evaluation operations proposed herein may be implemented in various ways, such as by modifying the existing API for how a NRF may interact with NFs via defining new notification types, or by extending existing notifications supported by 3GPP standards.

A first example approach may include augmenting the existing API interface between NRFs and NFs to utilize implicit subscriptions to provide updates on NFs suspended due to certificate expiry. In embodiments where an NF does not create an explicit subscription with the NRF, an NRF may normally be limited in its ability to communicate to an NF.

However, some NFs, depending on functionality, may have implicit subscriptions, where a producer NF can send notifications or messages to a consumer NF. In this example, the NRF may be the producer NF (e.g., for responding to discovery requests), and can utilize implicit subscriptions with other NFs to send status updates, using a new notification type. For example, when an NF registers with an NRF, part of the information the NF provides for creating its NFProfile may be a “defaultNotificationSubscriptions” value for defining a default notification endpoint (e.g., a contact address) via which the NF may receive updates, or a “callbackUri”, a default notification URI (uniform resource identifier). The NRF may use one of the defined default addresses to send the status updates even without an explicit subscription. The proposed approach may therefore utilize a configurable API to establish a connection by the NRF towards an NF without the need for the explicit subscription by the NF to the NRF. The new or custom interface notification may take the form of, e.g.,:
POST/PUT://<nNRF_Notification>/indication_of_status{
NFInstanceID: <nfinstance of the NF which is set to “SUSPENDED”
Reason: “Certificate_expiry”
TimeWhenStatusWouldBeSuspended: <Time_when_NRF_Would_set_the_NF_to_Suspended>
   The consumer NF may acknowledge the request with a response, such as a “204: No Content” message.

Due to this approach being applicable without NFs creating explicit subscriptions, it may involve sending out notifications to more NFs than necessary or would find the information useful. Further, this approach may involve defining a new or custom notification type, which may include a larger change to the API standards than the next proposal, and therefore may require more custom equipment modifications and involve less potential support among system vendors for network components.

Another approach may include merely enhancing the existing 3GPP standard-based API by expanding potential values of existing data types. Extending existing notification and enumeration types already supported by 3GPP may allow for a simpler implementation that may benefit from more widespread support, or may cause no problems when utilized with components that support existing 3GPP standards but haven't implemented the updates proposed herein.

Under this approach, a consumer NF can create an explicit subscription to the NRF utilizing existing 3GPP-defined subscription functionality as discussed in regard to subscriptions database 120 of FIG. 1. The subscription may request that the C-NF be notified when an NRF updates designated NFs to “suspended due to certificate expiration” status. The “suspended due to certificate expiration” status may be a new status added to existing status options for which an NF may subscribe for updates.

The process may include an NF registering with the NRF, for example according to 3GPP TS (technical specification) 29.510 5.2.2.2.2. The NF may utilize a REST API PUT or POST message to create an NFProfile for the NF'sNfInstanceID. The NF may then create subscription at the NRF for status updates regarding NF instances in the same PLMN (Public Land Mobile Network), for example. The subscription may be created according to 3GPP TS 29.510 5.2.2.5.2, in some embodiments, and may involve providing a URI address at which to receive the updates. In an example, TS 29.510, Table 6.1.3.4.3.1-2 describes data structures supported by a POST request body to create a subscription resource, where the provided SubscriptionData in the request body may contain the input parameters for the subscription, e.g.: Target NF type, Target Service Name, and Callback URI of the Requester NF. If an NF wishes to subscribe for status updates on itself, such as to be notified when it has been suspended due to certificate expiration, the NF may provide its own NF Instance ID when identifying which NFs for which it wishes to subscribe.

Table 300 shows a number of attributes that may be included in SubscriptionData provided when an NF subscribes to an NRF, according to TS 29.510 Table 6.1.2.16-1. One attribute may include “subscrCond”, or subscription condition, providing one or more conditions identifying the set of NF Instances whose status is requested to be monitored. SubscrCond can specify a specific NF Instance ID of an NF Instance to monitor (see, e.g., TS 29.510 Table 6.1.6.2.35-1, providing that a SubscrCond data type can include an NfInstanceIdCond, allowing subscription to a given NF instance; and TS 29.510 Table 6.1.6.2.36-1, showing that an NfInstanceIdCond data type can include an NF instance Id value, nfInstanceId). Accordingly, when subscribing for status updates, an NF may specify a particular NF Instance ID to monitor, which may include an NF specifying its own Instance ID for status updates on itself.

Another attribute of SubscriptionData may include “reqNotifEvents”, or requested notification events, specifying a list of event types on which the NF Service Consumer is interested in receiving updates. ReqNotifEvents may be provided as an array of elements of the “NotificationEventType” data type, the possible values for which may be specified in table 302. Table 302 may include TS 29.510 Table 6.1.6.3.6-1, showing potential values for NotificationEventType as when an NF is registered or deregistered, when an NF profile is updated, or when shared data for an NF is changed.

The proposed solution presented herein includes updating Table 302 to include new statuses related to public key certificate validity of an NF instance. For example, a new status “NF_NEAR_EXPIRY” may be added, indicating the certificate of the NF Instance is nearing expiration. This status may be useful for an NF to subscribe for updates on itself, potentially allowing the NF to renew its certificate proactively before it expires, and avoiding network interruptions due to the certificate expiration. Another new example status may include “NF_SUSPENDED_EXPIRY”, for when the NF instance has been suspended in the NRF due to the expiration of its certificate. This may be provided to the NF instance whose certificate has expired, or to other NFs that may have previously obtained a list of potential P-NFs that includes the suspended NF. NFs that subscribe for suspension due to certificate expiration updates may know not to attempt to create an SBI connection or perform a TLS handshake with the suspended NF, preventing network errors or delays.

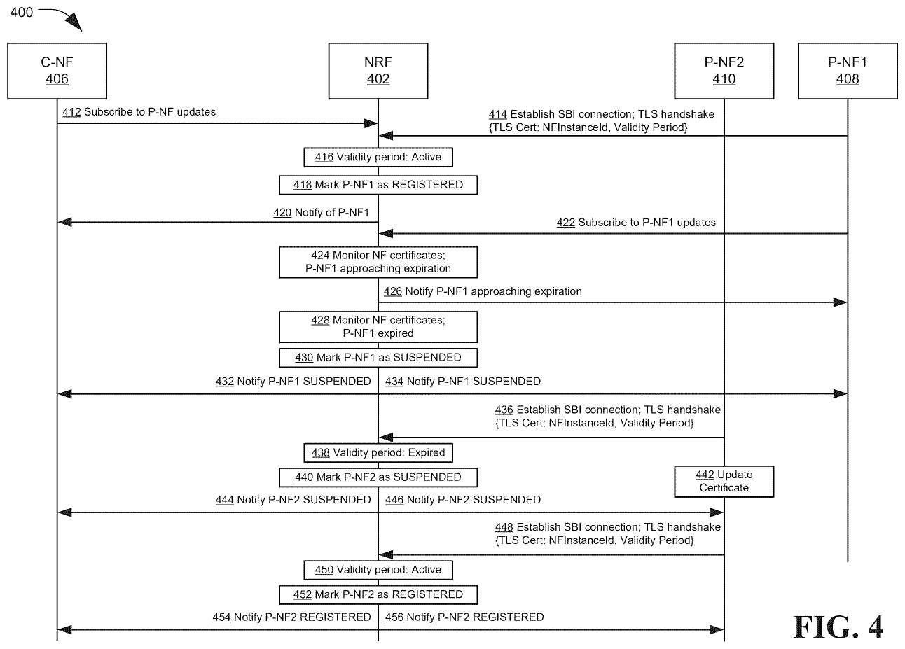

The proposed updates to the available statuses in Table 302 may enable NRF-based certificate evaluation and notifications using the existing explicit subscription and notification framework, and therefore may require minimal adjustments to equipment from existing 3GPP standards. In addition, because the notification system relies on an NF creating an explicit subscription, there may be no compliance issues when an NRF that supports certificate evaluation is deployed with NFs that do not support the feature, as the NFs will simply not create the new subscription types and will not receive unrecognized updates. Accordingly, the solution is compliant with existing API definitions as per 3GPP TS 29.500. An example process flow for the described certificate evaluation process is described in regard to FIG. 4.

FIG. 4 depicts a process flow diagram 400 of a system configured to perform network repository function certificate evaluation, in accordance with certain embodiments of the present disclosure. In particular, the process flow of diagram 400 depicts an example NRF monitoring certificate expiration and providing associated notifications. The diagram 400 may include a consumer NF (C-NF) 406, an NRF 402, a producer NF (P-NF) 1 408, and a P-NF2 410, which may correspond to elements described in regard to FIGS. 1 and 2.

At 412, C-NF 406 may subscribe to NRF 402 for P-NF status updates. The subscription request may include SubscrptionData specifying a type of P-NF, specific P-NFs, or other NF categories, and may request specific types of status updates for the specified NFs, or for all status updates. For the purposes of diagram 400, it may be assumed that C-NF 406 requested updates for new NF registrations and suspension notifications, but not for certificates approaching expiration. The NRF 402 may create a subscription entry for the C-NF 406 based on the subscription request.

At 414, P-NF 1 408 may register with NRF 402 to create an NFProfile, which may include performing a TLS handshake to establish an SBI connection with NRF 402. Part of the TLS handshake may include providing a public key certificate for P-NF 1 408, which may include NFInstanceId information for P-NF 1 408, and a validity period or expiration time for the certificate.

At 416, NRF 402 may determine, based on the validity period, that the public key certificate is valid, and may create an NFProfile for P-NF 1 408. At 418, NRF 402 may mark P-NF 1 as “registered”, due to the current validity of the certificate. At 420, the NRF 420 may notify C-NF 406 regarding registering P-NF 1 408, assuming that it falls within the subscription parameters set by C-NF 406.

At 422, P-NF 1 408 may send a subscription request to NRF 402 for status updates on itself, P-NF 1. In particular, P-NF 1 408 may subscribe for updates regarding approaching certificate expiration and suspension status updates. NRF 402 may create a subscription entry for P-NF 1 408.

At 424, NRF 402 may monitor or audit NF certificates for registered NFs, to determine whether any certificates are expired or approaching expiration. NRF 402 may determine that the certificate for P-NF 1 408 is approaching expiration. Based on the subscription entries, NRF 402 may determine that P-NF 1 408 is subscribed for updates on approaching certificate expiration for P-NF 1 408, and accordingly may send a notification or update of the approaching expiration to P-NF 1, at 426.

At 428, NRF 402 may continue to monitor NF certificates, and may determine that the certificate for P-NF1 has expired. In response, NRF 402 may update the status of P-NF1 408 to “suspended” or “suspended due to certificate expiration” in its database. Due to the suspended status, NRF 402 may not provide information regarding P-NF1 408 in response to discovery requests. Additionally, NRF 402 may send out notifications or updates based on any NFs subscribed for status updates on P-NF1 408. This may include sending a notification to C-NF 406 that P-NF 1 408 has been suspended, at 432, and a similar notification to P-NF 1 408, at 434.

At 436, P-NF 2 410 may attempt to register with NRF 402, such as by performing a TLS handshake to establish an SBI connection. P-NF2 410 may also subscribe for updates on itself, as part of the registration or as a separate operation. At the point of registration or at a later point, NRF 402 may determine that the validity period for P-NF 2 410 has expired, at 438. In response, NRF 402 may set the status of P-NF 2 410 to “suspended”, at 440. That is, even if P-NF 2's public key certificate is expired when attempting to perform a TLS handshake and register, the NRF may still obtain the Instance ID of P-NF 2 410 from the subjectAltName in the certificate, and set the status to suspended. NRF 402 may send status updates as appropriate, such as to C-NF 406 at 444, and P-NF 2 410 at 446.

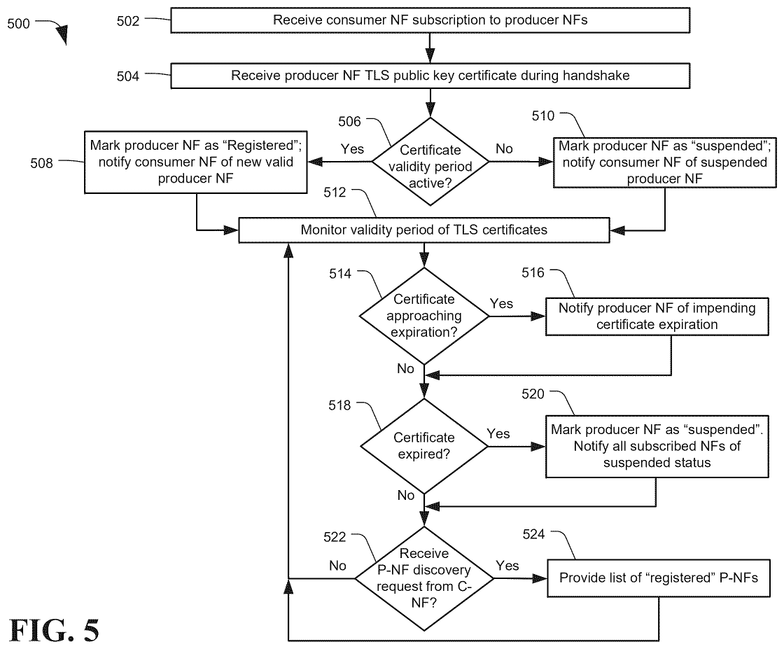

While NRF 402 was updating the status of P-NF 2 410 to suspended at 440, or after (e.g., in response to) receiving the notification that it had been suspended at 446, P-NF 2 410 may update its certificate with a new validity period, at 442. P-NF 2 410 establish a new SBI connection with NRF 402 using another TLS handshake, and provide the updated certificate with its new validity period, at 448. NRF 402 may verify the new active validity period, at 450, and in response update the status of P-NF 2 410 to “registered”, at 452. Based on updating the status to registered, NRF 402 send out subscription notifications as appropriate, such as to C-NF 402 at 454, and to P-NF 2 at 456. An example method for certificate evaluation at an NRF is described in regard to FIG. 5.

FIG. 5 depicts a flowchart 500 of an example method for performing network repository function certificate evaluation, in accordance with certain embodiments of the present disclosure. In particular, the method of FIG. 5 may depict a process for performing public key certificate audits, updating NF statuses based on the certificate validity, and issuing updates or notifications based on the status updates. The method may be performed by devices and systems described herein, such as the network or NF repository function (NRF) of FIGS. 1, 2, and 4.

The method may include receiving a consumer NF subscription regarding producer NFs, at 502. The subscription may request to receive updates based on new registered producer NFs, and producer NFs that have been suspended due to expiration of their public key certificate. In some examples, the consumer NF and the specified producer NF on which to receive updates may be a same NF, such as when an NF subscribes for updates on an approaching expiration of its own certificate.

At 504, the method may include receiving a producer NF TLS public key certificate during a TLS handshake operation, for example in order to establish an SBI communication session between the producer NF and an NRF. The public key certificate may include a validity period or expiration time. At 506, the method may include determining whether the certificate validity period is active. If the validity period is active, the method may include marking or setting the producer NF to “registered” status, and notifying any subscribed consumer NFs of a new valid or registered producer NF, at 508. If the validity period is not active, the method may include marking the producer NF as “suspended” or “suspended due to certificate expiration”, and notifying any subscribed consumer NF of a suspended producer NF, at 510.

At 512, the method may include monitoring or auditing the validity period of public key certificates for NFs that have created NF profiles with the NRF. The method may include determining whether a certificate is approaching expiration, at 514. If so, the method may include notifying the producer NF in question of the impending certificate expiration, at 516. The method may include notifying the producer NF approaching expiration only if the NF is subscribed for that status update, or the NRF may be configured to notify the producer NF even without an explicit subscription. In some embodiments, other NFs may subscribe for impending certificate expiration updates, such as a different consumer NF, and those subscribed NFs may be notified accordingly.

The method may next include determining whether any certificates have expired, at 518. If so, the method may include marking the producer NF as “suspended” or “suspended due to certificate expiration”, and notifying all subscribed NFs of the suspended status, at 520.

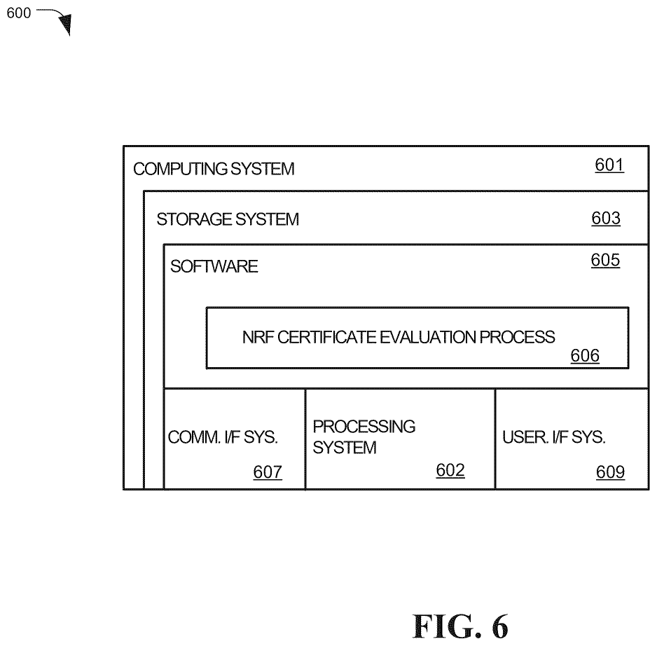

At 522, the method may include determining whether a discovery request for P-NFs has been received from a C-NF. If so, the method may include providing a list of “registered” P-NFs only, at 524. Information on P-NFs that have been suspended due to certificate expiration may not be provided in response to discovery requests, or may be provided along with an indication that the P-NF is currently suspended due to certificate expiration, and therefore cannot establish new SBI connections. However, as the P-NF may later rectify its expired certificate and updates may be sent to subscribed NFs that the P-NF is no longer suspended, providing details of the suspended P-NF in response to discovery requests may be appropriate in certain circumstances. If no discovery requests have been received, or all requests have been responded to, the method may include resuming monitoring or auditing of certificate validity periods, at 512. A computing system configured to perform the operations of the processes of FIGS. 4 and 5 is described in regard to FIG. 6

FIG. 6 illustrates an apparatus 600 including a computing system 601 that is representative of any system or collection of systems in which the various processes, systems, programs, services, and scenarios disclosed herein may be implemented. Examples of computing system 601 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 may include, but is not limited to, processing system 602, storage system 603, software 605, communication interface system 607, and user interface system 609. Processing system 602 may be operatively coupled with storage system 603, communication interface system 607, and user interface system 609.

Processing system 602 may load and execute software 605 from storage system 603. Software 605 may include and implement NRF certificate evaluation process 606, which may be representative of any of the operations for receiving and recording validity periods for public key certificates obtained from NFs during handshake operations, monitoring or auditing the validity periods for expiration, changing a status of NFs to suspended due to certificate expiry at the NRF, not returning suspended NFs in response to discovery requests, and sending notifications or updates on status changes to suspended due to certificate expiration, as discussed with respect to the preceding Figures. When executed by processing system 602 to receive and respond to a resource discovery request, software 605 may direct processing system 602 to operate as described herein for at least the various processes, operational scenarios, and sequences discussed in the foregoing implementations. Computing system 601 may optionally include additional devices, features, or functionality not discussed for purposes of brevity.

In some embodiments, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 may include general purpose central processing units, graphical processing units, application specific processors, and logic devices, as well as any other type of processing device, combinations, or variations thereof.

Storage system 603 may comprise any memory device or computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including NRF certificate evaluation process 606 among other functions) may be implemented in program instructions that may, when executed by processing system 602, direct processing system 602 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to provide positive resource discovery responses for suspended resources as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

While some examples provided herein are described in the context of 5G communication networks operated in a cloud environment, it should be understood the systems and methods described herein for positive resource discovery responses for suspended resources are not limited to such embodiments, and may apply to a variety of other communication networks and resource discovery request environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A Network Repository Function (NRF) system, comprising:
one or more processors; and
a memory having stored thereon instructions that, upon execution by the one or more processors, cause the one or more processors to:
receive a public key certificate from a first network function (NF), wherein the public key certificate includes a validity period;
monitor the validity period for expiration; and
set a status of the first NF to suspended in response to the validity period expiring.

2. The NRF system of claim 1, wherein the instructions comprise further instructions that, upon execution by the one or more processors, cause the one or more processors to:
receive a discovery request from a second NF seeking information on a set of one or more NFs that includes the first NF; and
do not provide information on the first NF in response to the discovery request based on the first NF being suspended due to expiration of the public key certificate.

3. The NRF system of claim 2, wherein the instructions comprise further instructions that, upon execution by the one or more processors, cause the one or more processors to:
receive a subscription request from the second NF requesting updates on NFs that are suspended due to expiration of corresponding public key certificates; and
send a notification to the second NF based on the subscription request and setting the status of the first NF to suspended.

4. The NRF system of claim 3, wherein the instructions comprise further instructions that, upon execution by the one or more processors, cause the one or more processors to:
receive the public key certificate during a first transport layer security (TLS) handshake operation with the first NF;
receive an updated public key certificate during a second TLS handshake operation with the first NF, the updated public key certificate having a new validity period;
determine that the new validity period is active; and
update the status of the first NF from suspended to registered based on the updated public key certificate.

5. The NRF system of claim 4, wherein the instructions comprise further instructions that, upon execution by the one or more processors, cause the one or more processors to:
send a second notification to the second NF based on the subscription request and updating the status of the first NF from suspended to registered, wherein the subscription request requests updates on NFs that are registered.

6. The NRF system of claim 5, wherein the instructions comprise further instructions that, upon execution by the one or more processors, cause the one or more processors to:
receive a second subscription request from the first NF requesting an update when the first NF is changed to suspended status due to expiration of the public key certificate; and
send a third notification to the first NF based on the second subscription request and setting the status of the first NF to suspended.

7. The NRF system of claim 6, wherein the instructions comprise further instructions that, upon execution by the one or more processors, cause the one or more processors to:
receive the second subscription request, further requesting an update when the public key certificate is approaching expiration;
monitor the validity period for being within a selected threshold time of expiring; and
send a fourth notification to the first NF based on the second subscription request and the validity period being within the selected threshold time of expiring.

8. The NRF system of claim 7, wherein the instructions comprise further instructions that, upon execution by the one or more processors, cause the one or more processors to:
send notifications regarding the first NF being suspended due to the validity period expiring based on explicit subscriptions created between NFs and the NRF, wherein notification event types for the explicit subscriptions include suspension due to certificate expiration.

9. The NRF system of claim 8, wherein the notification event types for the explicit subscriptions include certificates approaching expiration.

10. The NRF system of claim 1, wherein the instructions comprise further instructions that, upon execution by the one or more processors, cause the one or more processors to:
receive a request to create an NF profile at the NRF for a second NF, the request including a default uniform resource identifier (URI) for receiving notifications; and
send a notification to a second NF indicating that the first NF has been suspended due to certificate expiration, the notification being sent via implicit subscription to the default URI utilizing a custom notification type.

11. A method comprising:
operating a network repository function (NRF) of a mobile network, including:
receiving a public key certificate from a first network function (NF), wherein the public key certificate includes a validity period;
monitoring the validity period for expiration; and
setting a status of the first NF to suspended in response to the validity period expiring.

12. The method of claim 11 further comprising:
receiving a discovery request from a second NF seeking information on a set of one or more NFs that includes the first NF; and
not providing information on the first NF in response to the discovery request based on the first NF being suspended due to expiration of the public key certificate.

13. The method of claim 11 further comprising:
receiving a subscription request from a second NF requesting updates on NFs that are suspended due to expiration of corresponding public key certificates; and
sending a notification to the second NF based on the subscription request and setting the status of the first NF to suspended.

14. The method of claim 11 further comprising:
receiving the public key certificate during a first transport layer security (TLS) handshake operation with the first NF;
receiving an updated public key certificate during a second TLS handshake operation with the first NF, the updated public key certificate having a new validity period;
determining that the new validity period is active; and
updating the status of the first NF from suspended to registered based on the updated public key certificate.

15. The method of claim 14 further comprising:
receiving a subscription request from a second NF requesting updates when NFs are registered; and
sending a notification to the second NF based on the subscription request and updating the status of the first NF from suspended to registered.

16. The method of claim 11 further comprising:
receiving a subscription request from the first NF requesting an update when the first NF is changed to suspended status due to expiration of the public key certificate; and
sending a notification to the first NF based on the subscription request and setting the status of the first NF to suspended.

17. The method of claim 11 further comprising:
receiving a subscription request from the first NF requesting an update when the public key certificate is approaching expiration;
monitoring the validity period for being within a selected threshold time of expiring; and
sending a notification to the first NF based on the subscription request and the validity period being within the selected threshold time of expiring.

18. The method of claim 11 further comprising:
sending notifications regarding the first NF being suspended due to the validity period expiring based on explicit subscriptions created between NFs and the NRF, wherein notification event types for the explicit subscriptions include suspension due to certificate expiration.

19. The method of claim 18, wherein the notification event types for the explicit subscriptions include certificates approaching expiration.

20. The method of claim 11 further comprising:
receiving a request to create an NF profile at the NRF for a second NF, the request including a default uniform resource identifier (URI) for receiving notifications; and
sending a notification to a second NF indicating that the first NF has been suspended due to certificate expiration, the notification being sent via implicit subscription to the default URI utilizing a custom notification type.
